(19) United States
(12) Patent Application Publication
(10) Pub. No.: US 2012/0264903 A1
(43) Pub. Date: Oct. 18, 2012

(54) MULTIMODAL COPOLYMERS, PRODUCTION OF SAME, AND USE THEREOF IN BULK CONTACT ADHESIVE

(75) Inventors: Thilo Dollase, Hamburg (DE); Alexander Prenzel, Hamburg (DE); Niko Lübbert, Hamburg (DE)

(73) Assignee: TESA SE, Hamburg (DE)

(21) Appl. No.: 13/391,092

(22) PCT Filed: Dec. 20, 2010
(86) PCT No.: PCT/EP2010/070222

§ 371 Date: Apr. 4, 2012

(30) Foreign Application Priority Data
Jan. 8, 2010 (DE) 10 2010 000 750.1

(51) Int. Cl. C09J 133/10; C09J 133/08; C08F 20/12

(52) U.S. Cl. 526/328

(57) ABSTRACT

Radical copolymerization method comprising the steps of (a) providing a monomer or monomer mixtures having unsaturated C═C double bonds; (b) starting the radical (co)polymerization by means of a first addition of an initiator, and then (c) adding at least one amino acid as a regulating substance, wherein the addition of the regulating substance takes place after reaching a conversion of 50% relative to the unsaturated C═C double bonds of the monomer or monomer mixture provided in step (a)

This is a 371 of PCT/EP2010/070222 filed 20 Dec. 2010 (international filing date), claiming priority of German application 10 2010 000 750.1, filed Jan. 8, 2010.

The present invention relates to a radical (co)polymerization process and also to (co)polymers obtainable by this process. The invention further relates to pressure-sensitive adhesives comprising these (co)polymers, and to pressure-sensitive adhesive products based on such pressure-sensitive adhesives.

### BACKGROUND OF THE INVENTION

Double-sidedly pressure-sensitive adhesive products offer a great benefit in areas of application of connective adhesive bonding, on account of their easy processability as compared with liquid adhesives, their permanent tack, and the fact that they do not have to cure after application. One distinct group among such products are those which comprise a carrier material. They include double-sided adhesive tapes, and carrier-free products, such as what are called adhesive transfer tapes, for example. In both product categories the top and bottom surfaces are pressure-sensitively adhesive—that is, permanently adhesive. In order to protect these surfaces from contamination and unwanted premature bonding before the time of use, the pressure-sensitive adhesive surfaces are typically lined temporarily with redetachable auxiliary carrier materials. Where the double-sidedly pressure-sensitive adhesive products are sheet products, then the bottom face is lined using one sheet of an auxiliary carrier material, and the top face using a second. Where the double-sidedly pressure-sensitive adhesive products are converted into roll form, then likewise two auxiliary carrier materials may be employed, or else a single web, which is provided on its front and rear faces in such a way that at the time of application it can be detached from the pressure-sensitive adhesive product again, first from one pressure-sensitive adhesive surface and thereafter from the second.

In applications of connective adhesive bonding a requirement which arises continually is that of achieving an application-compatible combination of adhesive and cohesive properties on the part of the pressure-sensitive adhesive product. Among adhesive properties is the bond strength, which represents a central characterizing variable for pressure-sensitive adhesives and adhesive layers produced from them. Among the cohesive properties is the shear strength, a further central characterizing variable for pressure-sensitive adhesives and adhesive layers produced from them. Typically, cohesive properties and adhesive properties are mutually contradictory characteristics. Optimizing the one frequently results in a deterioration in the other. The continual object is to balance out cohesive and adhesive properties in a pressure-sensitive adhesive in a manner relevant to the application. Furthermore, the fundamental object exists of finding approaches via which it is possible simultaneously to improve both the cohesive properties and the adhesive properties of a pressure-sensitive adhesive.

Whereas the bond strength and the shear strength represent common methods for the fundamental and easily accomplishable characterization of pressure-sensitive adhesives and pressure-sensitive adhesive products comprising the former, the criteria which determine the selection of a pressure-sensitive adhesive product for a given use are usually performance criteria associated indirectly with said properties. Hence the adhesive properties of the pressure-sensitive adhesive tend to be associated with the “softness” of the system, while the cohesive properties tend to be associated with the “hardness”. One example of an application-relevant requirement which is associated with the cohesive properties of the adhesive layer is its residueless redetachability from a bond surface. One example of a performance-relevant requirement which is associated with the adhesive properties of the adhesive layer is the peel increase or lamination behavior of the pressure-sensitive adhesive layer on a surface to which bonding is to take place; in other words, how quickly, after application of the pressure-sensitive adhesive product, the ultimate bond strength is achieved for an adhesive bond. For application-relevant criteria of this kind as well it is the case that they exert mutual influence on one another, and frequently, again, the object is to balance out and/or improve simultaneously those application-relevant criteria which correlate with the cohesion of a pressure-sensitive adhesive and those application-relevant criteria which correlate with the adhesive properties of a pressure-sensitive adhesive.

If the object stated above was not already of decided complexity, a further necessity, moreover, is not only to provide pressure-sensitive adhesive systems with a balanced performance profile but also to ensure that these pressure-sensitive adhesive systems have processability as well, more particularly sufficient coating/slitting and diecutting characteristics in relation to ease of processing, quality, and economics. This additional requirement narrows down still further the amount of pressure-sensitive adhesive systems that are suitable. Following from this is the requirement to provide additional and/or improved approaches via which an appropriate balance of properties profile and processability is achieved.

One important class of raw material for pressure-sensitive adhesives (PSAs) are the acrylate-based adhesives. Acrylate-based PSAs are especially notable for their suitability in adhesive bonds which are of high durability and high quality (optical quality, for example). They are polymerized typically by copolymerization of suitable monomer mixtures in organic solvents, in water or in bulk, and are crosslinked usually by addition of crosslinkers or by exposure to radiation and/or heat. Influencing variables for controlling the technical adhesive properties are in particular the molar mass of the base polymers thus produced, the composition of the base polymers, the nature and degree of crosslinking, and, where appropriate, the nature and amount of additions such as tackifying resins and plasticizers. The commonplace approaches are treated, for example, in the treaties by Everaerts [A. I. Everaerts, L. M. Clemens in “Adhesion Science & Engineering”, Vol. 2, M. Chaudhury, A. V. Pocius, (ed.), 2002, Elsevier, Amsterdam, pp. 485-505] or Satas [D. Satas et al. and A. Zosel et al. in “Handbook of Pressure Sensitive Adhesives Technology”, D. Satas (ed.), 3^{rd} edn., 1999, Satas & Associates, Warwick, pp. 444-549].

It has already been recognized that one way of controlling the balance of cohesion and adhesion and possibly even of improving both criteria simultaneously lies in mixing different acrylate copolymers with one another. In order, for example, where shear strength and bond strength are already good, to improve the tack of label adhesives as well, Satas proposes adding a dispersion or solution of a relatively short-chain acrylate copolymer to a dispersion or solution of a high molecular mass acrylate copolymer [D. Satas et al. in “Handbook of Pressure Sensitive Adhesives Technology”, D. Satas (ed.), 3^{rd} edn., 1999, Satas & Associates, Warwick, p. 455f and p. 485].

The molecular weight of polymers can be adjusted (reduced) by using suitable chain transfer agents [H.-G. Elias, Makromoleküle, Vol. 1, 6^{th} ed., 1999, Wiley-VCH, Weinheim, pp. 334-340]. Chain transfer systems specified include short-chain and long-chain alkyl mercaptans. In addition, limonene and α-methylstyrene dimer have been cited as chain transfer systems.

Through the influence of chain transfer agents it is possible to prepare short-chain polymers which are then, for example, formulated in binary polymer mixtures, in other words starting from two solutions or dispersions of polymers with different molecular weights.

In order to meet the requirement for evermore efficient production, mixing approaches of this kind are often not preferred, since the at least two polymeric constituents for a binary polymer mixture have to be prepared in separate polymerization batches and mixed with one another in a subsequent additional operation.

It is also conceivable, however, to control the molecular weight distribution in a polymerization in such a way that the resulting polymer already, from this single polymerization, is characterized by two curve maxima in the molecular weight distribution. Each of these maxima then relates to what is called a polymer mode. In the case of two maxima, accordingly, the term “bimodal molecular weight distribution” or, simply, “bimodal polymers” is used. Distributions with more than two maxima are referred to, correspondingly, as trimodal in the case of three maxima, and so on. Generally speaking, in the sense of this invention, polymers are referred to as multimodal when there is more than one curve maximum in the molecular weight distribution. It is also possible for individual curve maxima not to be fully resolved, with the consequence, for example, that there is only one maximum and the other polymer mode or modes is or are detectable as one or more shoulders.

A process for preparing bimodal acrylate PSAs is proposed by WO 2004/056884. In a two-stage polymerization, the long-chain polymer mode is obtained in a first stage, and the short-chain polymer mode, by influence of a chain transfer agent, in a second stage. Chain transfer systems cited are alcohols, ethers, dithioethers, dithiocarbonates, trithiocarbonates, nitroxides, alkyl bromides, thiols, TEMPO (2,2,6,6-tetramethylpiperidine-1-oxyl) and TEMPO derivatives. Described more particularly is the use of isopropanol as chain transfer agent. Isopropanol as chain transfer agent is advantageous in many cases, since after a drying operation it does not remain in the product, is unobjectionable on health grounds, and is not critical in relation to odor and color. Owing to a relatively low chain transfer constant, however, it is necessary to use a decidedly high proportion of this chain transfer agent, and this may affect the solution properties of the resultant polymer.

Furthermore, EP 1 882 707 indicates bimodal polymers and processes for preparing them. Chain transfer agents cited are alcohols, ethers, dithioethers, dithiocarbonates, trithiocarbonates, nitroxides, alkyl bromides, thiols, TEMPO (2,2,6,6-tetramethylpiperidine-1-oxyl) and TEMPO derivatives, with isopropanol, benzyl dithiobenzoate, ethyl dithioacetate, bis-2,2′-phenylethyl trithiocarbonate, and dibenzyl trithiocarbonate being emphasized as particularly preferred chain transfer variants. Not all of these chain transfer systems are propagated commercially. Furthermore, substances containing sulfur often have at least a slight yellow tinge, which may be related to the substance itself or else to impurities present to a minor extent. In adhesive bonding applications of high optical quality, however, a high degree of cleanness is required—in other words, any yellow tinge, even only slight, is customarily to be avoided.

All of these examples per se undertake an attempt to achieve a specific technical adhesive performance profile by constructing base polymers for PSA by realization of a bimodal molecular weight distribution comprising long-chain and short-chain polymer modes.

None of the texts recited, however, discloses an approach which as well as setting the specific technical adhesive performance profile also ensures good processability, more particularly an improved coating behavior in relation to ease of processing, quality, and economics.

There continues, therefore, to be a need to provide PSAs which exhibit an outstanding balance between cohesive and adhesive properties and at the same time show improved processability. The object, moreover, is to specify chain transfer systems which resolve the disadvantages associated with those known from the prior art and differ from them positively in terms of aspects such as degree of cleanness (color), odor, chain transfer efficiency, economics, compatibility with other formulating constituents, and hazard potential.

### SUMMARY OF THE INVENTION

It has been possible to achieve this object through the use of amino acids as chain transfer substances in the radical (co)polymerization of monomers, especially acrylic and/or methacrylic monomers, for the preparation of (meth)acrylate copolymers, preferably of monomer mixtures comprising at least 70% by weight of at least one acrylic and/or methacrylic ester. The expression (co)polymerization and the term (co)polymerizing here, in the sense of the present invention, encompass not only copolymerization of different monomers but also polymerization of uniform monomers and the copolymerizing or polymerizing thereof, respectively. Preferably, in the sense of the present invention, the (co)polymerization is a copolymerization.

The invention accordingly provides a radical (co)polymerization process comprising the following steps:

(a) providing a monomer or monomer mixture with unsaturated C═C double bonds;

(b) starting the radical (co)polymerization by a first addition of an initiator; and subsequently

(c) adding at least one amino acid as chain transfer substance,

the addition of the chain transfer substance taking place after attainment of a conversion of 50%, based on the unsaturated C═C double bonds of the monomer or monomer mixture provided in step (a).

### DETAILED DESCRIPTION

In one preferred embodiment of the invention the chain transfer substance is added after attainment of a conversion of 60%, more preferably 70%, based on the unsaturated C═C double bonds. In another embodiment of the invention the chain transfer substance is added until attainment of a conversion of 95%, preferably 90%, more preferably 80%, based on the unsaturated C═C double bonds of the monomer or monomer mixture provided in step (a). For determining the conversion it is possible to monitor the reaction by means of a NIR probe in accordance with Test Method E. Other methods for determining conversion, such as gas-chromatographic methods, for example, are likewise informative and may likewise be employed for monitoring the conversion. Adding the chain transfer substance before attainment of a conversion of 50%, based on the unsaturated C═C double bonds of the monomer or monomer mixture provided in step (a), means that the resulting (co)polymers do not have the required processability with simultaneously excellent balance of cohesive and adhesive properties.

The chain transfer substance is preferably added in step (c) of the process of the invention in an amount of 0.05 to 5 mol %, based on the monomer or monomer mixture provided in step (a). As chain transfer substance it is preferred to use chain transfer systems based on natural and/or nonnatural, aromatic and nonaromatic amino acids which contain thiol, selanyl and/or hydroxyl groups.

In one preferred embodiment of the invention the at least one amino acid has at least one sulfanyl group (also referred to below as thiol groups or —SH group), at least one selanyl group (also referred to below as —SeH group) and/or a hydroxyl group (also referred to below as —OH group). In one particularly preferred embodiment of the invention the aforementioned groups are terminal in the amino acid, i.e., primary. However, secondary and tertiary embodiments are also conceivable.

The at least one amino acid is preferably selected from a group of compounds of the following general structural formulae (I) and (II)

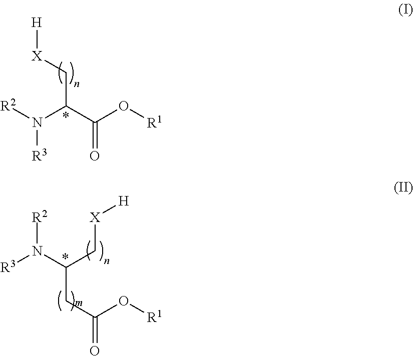

where R¹, R², and R³ in each case independently of one another are selected from the group consisting of alkyl, alkenyl, alkynyl, aryl, heterocyclyl, hydrogen, acyl, alkanoyl, cycloalkanecarbonyl, arenecarbonyl, alkoxycarbonyl, carbamoyl, and sulfonyl, or where R1 is selected from the group consisting of alkyl, alkenyl, alkynyl, aryl, heterocyclyl, hydrogen, acyl, alkanoyl, cycloalkanecarbonyl, arenecarbonyl, alkoxycarbonyl, carbamoyl, and sulfonyl, and R2 and R3 together with the N atom to which they are attached represent a cyclic group. X in the formulae (I) and (II) is selected from oxygen (O), sulfur (S) or selenium (Se), and the index n is a natural whole number, including zero. Preferably 0≦n≦18. Index m is a natural whole number greater than 0. Preferably m is 1 or 2.

In one preferred embodiment of the invention, R¹ in formulae (I) or (II) is selected from the group (i) encompassing
(i) linear and branched C₁ to C₁₈ alkyl radicals, linear and branched C₂ to C₁₈ alkenyl radicals, linear and branched C₂ to C₁₈ alkynyl radicals, aryl radicals, cycloaliphatic, aliphatic, aromatic heterocycles, hydrogen, and

R² and R³ are selected from the above group (i) or from the group (ii), encompassing:
(ii) acyl radicals, more particularly alkanoyl radicals and cycloalkanecarbonyl radicals and arenecarbonyl radicals (—C(O)—R′), alkoxycarbonyl radicals (—C(O)—O—R′), carbamoyl radicals (—C(O)—NR′R″), sulfonyl radicals (—SO₂R′), where R′ and R″ in each case are radicals selected independently of one another from the group (i).

Where R2 and R3, together with the N atom to which they are attached, represent a cyclic group, R2 and R3 preferably form a substituted or unsubstituted C1-C6 alkylene, C1-C6 alkylene-O—C1-C6 alkylene, C1-C6 alkylene-CONH—C1-C6 alkylene or C1-C6 alkylene-COO—C1-C6 alkylene.

The amino acids of the formulae (I) and (II) have a stereogenic center (labeled by the * star in the image) and are therefore chiral. In one advantageous embodiment of the invention the at least one amino acid is used as an optically pure substance in the (D) or (L) configuration or as a racemic mixture or any desired further mixture.

In one particularly preferred embodiment of the invention, the amino acid has a melting point of 20° C. or higher, preferably of 50° C. or higher. The amino acid is preferably cysteine or a derivative thereof, preferably acylated on the nitrogen. With particular preference the acid in question is N-acetylcysteine. N-Acetylcysteine is suitable in the form of N-acetyl-(L)-cysteine, N-acetyl-(D)-cysteine, and any desired mixture of these enantiomers, and also in the form of a racemic mixture.

As monomers or monomer mixtures which are (co)polymerized in the process of the invention it is possible to use all of the radically polymerizable C═C double bond-containing monomers that are known to the skilled person. Preference here is given to using α,β-unsaturated carboxylic acids and their derivatives, of the general structure

CH₂═C(R¹)(COOR²) (III),

as reactants, where R¹═H or CH₃ and R²═H or linear, branched or cyclic, saturated or unsaturated alkyl radicals having 1 to 30, preferably having 4 to 18, carbon atoms, with or without additional substituents such as hydroxyl, C1-C6 alkoxy, halogen, hydroxyalkyl, amino, alkylamino, acylamino, carboxyl, alkoxycarbonyl, sulfonic acid, sulfonic ester, alkylsulfonyl, arylsulfonyl, sulfonyl, and sulfonamide groups.

Monomers which are used with great preference in the sense of the general structure (III) comprise acrylic and methacrylic esters with alkyl groups consisting of 4 to 18 C atoms. Specific examples of compounds employed, without wishing this recitation to impose any restriction, are as follows:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethylacrylate, methoxy-polyethylene glycol methacrylate 350, methoxy-polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropyl-acrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α-methylstyrene, o- and p-methylstyrene, o-butylstyrene, 4-n-butylstyrene, 4-n-decylstyrene, 3,4-dimethoxystyrene, macromonomers such as 2-polystyrene-ethyl methacrylate (molecular weight M_{w} of 4000 to 13 000 g/mol), polymethyl methacrylate-ethyl methacrylate (M_{w} of 2000 to 8000 g/mol).

Additionally it is possible in principle, in the sense of the invention, to use all vinylically functionalized compounds which are copolymerizable with the abovementioned monomers.

The monomers may advantageously also be selected such that they contain functional groups which support subsequent radiation-chemical crosslinking (as for example by electron beams, UV). Suitable copolymerizable photoinitiators are, for example, benzoin (meth)acrylate monomers and (meth)acrylate-functionalized benzophenone derivative monomers which support crosslinking by electronic irradiation, for example tetrahydrofurfuryl(meth)acrylate, N-tert-butyl(meth)acrylamide, allyl(meth)acrylate, this recitation not being conclusive.

In one preferred embodiment of the process of the invention the monomer mixture comprises at least one acrylic and/or methacrylic ester. With particular preference the monomer mixture comprises at least 70% by weight of at least one acrylic and/or methacrylic ester.

The present invention further provides (co)polymers obtainable by the process of the invention. In one preferred embodiment the (co)polymer is a (meth)acrylate (co)polymer which has at least one short-chain and one long-chain polymer mode (a) and (b):

(a) a short-chain polymer mode having a molecular weight M_{P}(short) of at least 5000 g/mol and not more than 100 000 g/mol, preferably of at least 15 000 g/mol and not more than 60 000 g/mol, and

(b) a long-chain polymer mode having a molecular weight M_{P}(long) of at least 500 000 g/mol and not more than 3 000 000 g/mol, preferably of at least 800 000 g/mol and not more than 2 000 000 g/mol. The molecular weights M_{P}(short) and M_{P}(long) here are determined at the corresponding local maximum of the molecular weight distribution or, if the molecular weight distribution maximum of this polymer mode is not resolved and occurs merely as a shoulder in the molecular weight distribution, at the point of the change in the direction of curvature in the region of the convex bulge in the corresponding shoulder.

In one particularly preferred embodiment of the invention the (co)polymer of the invention comprises at least 50% by weight, preferably at least 70% by weight, more preferably 90% by weight of the long-chain polymer mode (b), based on the total amount of the short-chain and long-chain polymer modes (a) and (b).

In the sense of the present invention, the molecular weights recited means those obtained via gel permeation chromatography determinations. Dissolved samples of the (co)polymers in question are to this end separated according to their hydrodynamic volume, and the resulting fractions are detected with a temporal offset. The molecular weight of the individual fractions is reported after calibration using polystyrene standards. The number average, M_{N}, corresponds to the first moment in the molecular weight distribution, the weight average M_{W}, to the second. These values are determined arithmetically from the measurement curves. Local maxima in the distributions M_{P}(i) for the polymer mode i are determined either likewise mathematically, via the analyzing software, or graphically from the measurement curves. Any shoulders are determined graphically from the measurement curves.

The invention additionally provides pressure-sensitive adhesives comprising the (co)polymer obtainable by the process of the invention. The present invention additionally provides pressure-sensitive adhesive products which comprise this pressure-sensitive adhesive. In one particular embodiment the pressure-sensitive adhesive product is a diecut laminating film.

In the pressure-sensitive adhesive products of the invention the PSA is present preferably in the form of a layer. The layer thickness of the PSA in the pressure-sensitive adhesive products of the invention is not subject to any particular restriction. In one particular embodiment this invention comprises pressure-sensitive adhesive products whose PSA has a layer thickness of at least 75 μm, preferably at least 150 μm, more preferably still at least 200 μm. Surprisingly it has been found that the pressure-sensitive adhesive products, despite high layer thicknesses, can be produced in very high optical quality in relation to coating pattern, absence of bubbles, and freedom from flow tracks.

The multimodal, more particular bimodal, (co)polymers of the invention can be employed outstandingly as/in adhesives, more particularly PSAs and heat-sealing compositions. The composition of the (co)polymers is selected in relation to the application. One important property for the multimodal, more particularly bimodal, (co)polymers, if they are used, for example, in adhesives, is their glass transition temperature T_{g}.

In order to obtain a desired glass transition temperature, the quantitative composition of the monomer mixture is advantageously selected such that the desired T_{g} value for the polymer is produced in accordance with an equation (E1) in analogy to the Fox equation [T. G. Fox, Bull. Am. Phys. Soc. 1956, 1, 123ff.].

$$\frac{1}{{T}_{g}} = {\sum }_{n} \frac{{W}_{n}}{{T}_{g , n}} \qquad ( E1 )$$

In this equation, n represents the serial number of the monomers used, Wₙ the mass fraction of the respective monomer n (% by weight), and T_{g,n} the respective static glass transition temperature of the homopolymer of the respective monomer n in K (kelvins). For PSAs the glass transition temperature is usually set at less than 25° C. A basis of comonomers is selected accordingly. For heat-sealing compositions, the glass transition temperature is preferably at least 0° C.

Multimodal, more particularly bimodal, copolymers advantageously have at least two sorts of comonomers in their composition, of which at least one sort carries, as a structural element, at least one functionality which contributes to a crosslinking reaction. The sort of comonomer which is capable of crosslinking is advantageously present at not less than 1 mol % in the comonomer composition. Amount-of-substance-based fractions of the at least one comonomer capable of crosslinking of more than 2.5 mol % are likewise highly suitable. It is very advantageous if the composition is selected, in relation to the at least one comonomer capable of crosslinking, in such a way that substantially all of the copolymers of at least one polymer mode are made crosslinkable through incorporation of this sort of comonomer. This polymer mode may be any polymer mode which is present: in the case of bimodal systems, correspondingly, it may be the polymer mode of long-chain polymer chains or the polymer mode of short-chain polymer chains. It is particularly advantageous to make all of the polymer chains crosslinkable.

For the crosslinking it is possible to use all of the processes and reagents that are known to the skilled worker. Depending on the process and/or reagent, the at least one sort of a (co)monomer capable of crosslinking that is selected is one which carries a correspondingly suitable functionality. Conceivable crosslinking processes are thermal and/or radiation-chemical processes, which are initiated, for example, via UV or electron beams. For supporting these crosslinking processes it is possible to use the auxiliaries customary in accordance with the prior art, such as catalysts and/or initiators.

Suitable photoinitiators for the UV crosslinking are preferably Norrish type I and type II splitters, with some possible examples of both classes being benzophenone, acetophenone, benzil, benzoin, hydroxyalkylphenone, phenyl cyclohexyl ketone, anthraquinone, thioxanthone, triazine or fluorenone derivatives, this recitation making no claim to completeness.

Very preferably a network is formed via chemical crosslinkers. For this purpose at least one sort of a crosslinker is added to the adhesive formulation. Particularly suitable crosslinkers in accordance with the inventive process are polyfunctional, more particularly di-, tri- or tetra-functional isocyanates, or polyfunctional, more particularly di-, tri- or tetra-functional epoxides. Use may likewise be made very favorably of metal chelate compounds. Use may also be made, however, of all other polyfunctional, more particularly di-, tri- or tetra-functional, compounds which are familiar to the skilled person and are capable of crosslinking polyacrylates in particular. Additionally it is possible to employ silanes, especially trialkoxyorganosilanes, which as part of their organic radical optionally carry a reactive functionality.

Combinations of different crosslinking approaches and/or crosslinker substances are possible as well. Correspondingly, the multimodal, more particularly bimodal, (co)polymers may also comprise two or more different sorts of comonomer which are capable of crosslinking.

For the use of the multimodal, more particularly bimodal, (co)polymers prepared by the process of the invention, the (co)polymers are optionally blended with at least one resin for optimization. As optionally employable tackifying resins it is possible in combination with the stated multimodal, more particularly bimodal, (co)polymers to use, without exception, all tackifying resins that are already known and are described in the literature. Representatives that may be mentioned include the rosins, their disproportionated, hydrogenated, polymerized, and esterified derivatives and/or salts, the aliphatic and aromatic hydrocarbon resins, terpene resins and terpene-phenolic resins. Any desired combinations of these and further resins may be used in order to adjust the properties of the resultant adhesive in accordance with requirements. In many processes of the invention, however, the addition of tackifying resins is not tolerated, owing to their effects of diminishing the optical quality of the bond layer.

As plasticizers, which can likewise be used optionally, it is possible to employ all plasticizing substances that are known from the technology of self-adhesive tapes. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. PSAs, as indicated above, may, furthermore, comprise additional constituents such as additives with rheological activity, catalysts, initiators, stabilizers, compatibilizers, coupling reagents, crosslinkers, antioxidants, further aging inhibitors, light stabilizers, flame retardants, pigments, dyes, fillers and/or expandants, and also, optionally, solvents.

Because of the short-chain polymer mode in the multimodal, more particularly bimodal, copolymers, it is frequently possible to do without the further addition of (migratable) plasticizers entirely or to reduce the amount in which they are used, without losing their positive effects on the performance profile.

With regard to the control of the polymerization for preparing multimodal, more particularly bimodal, (co)polymers by the addition of at least one amino acid as a chain transfer agent in the process of the invention, there are various conceivable possibilities. Two advantageous possibilities may be given as examples at this point. The skilled person is capable of designing further polymerization procedures on the basis of the present description (such as, for example, metering techniques for monomers and/or chain transfer agents), situated likewise within the bounds of this invention.

In a first example polymerization process, all of the monomers are introduced at the beginning of the polymerization. The fraction of a chain-transfer-regulated (shorter-chain) (co)polymer mode in relation to the overall polymer can be controlled, using at least one amino acid as chain transfer substance, by way of the point in time at which it is added. The earlier the chain transfer agent is added to the polymerization mixture, the higher the fraction of shorter-chain (co)polymer molecules. The chain transfer agent is added preferably at between about 30 minutes and 2 hours after the start of polymerization. Other times after the start of polymerization are likewise possible, however.

In this first example polymerization process, the molecular weight of the chain-transfer-regulated (shorter-chain) (co)polymer mode can be controlled by way of the amount of chain transfer agent used. The higher the selected amount of chain transfer agent used, the lower the resulting molecular weight of the corresponding (co)polymer mode.

In a second example polymerization process, a portion of the monomers desired for the polymerization is added only at a point in time after the start of the polymerization. The chain transfer agent in this case is added advantageously at the same point in time as the aforementioned monomer amount added later. The fraction of chain-transfer-regulated (shorter-chain) (co)polymers then results essentially from the amount of monomers present at this point in time of addition. The molecular weight of the chain-transfer-regulated (shorter-chain) (co)polymers is defined via the ratio of the chain transfer agent or agents used to the monomer amount present at the point in time of addition.

Bimodal (co)polymers result when there is only one addition of chain transfer agent. Trimodal (co)polymers are obtained by adding the chain transfer agent/agents at two different points in time after the start of polymerization. Tetramodal (co)polymers are obtained by adding the chain transfer agent/agents at three different points in time after the start of polymerization. Generally, n-modal (co)polymers are obtained by adding the chain transfer agent/agents at (n-1) different points in time after the start of polymerization.

A procedure which has proven particularly advantageous for the use of the chain transfer agents of the invention for the preparation of multimodal, more particularly bimodal, (co)polymers, shown here for a bimodal system, is as follows:

A monomer mixture is charged to a reactor filled with solvent and is heated to the boiling point. The polymerization is subsequently started by addition of a first amount of initiator. Via the monomer concentration and the ratio relative to the amount of initiator, it is possible to adjust the molar mass distribution, especially the average chain length, of the polymers of the long-chain polymer mode. After a predefined time, the chain transfer system is added. Via amount and point in time it is possible to adjust the fraction and the molecular weight of a short-chain polymer mode. Depending on what is required, further additions of initiator are made during the polymerization process. It is preferred to operate with initiators of low grafting effect during the early course of the polymerization. Toward the end of the polymerization, the use of initiators with a high grafting effect is appropriate, giving a polymer having a low residual monomer content.

This approach is notable for stable operating conditions and a comparatively simple regime. As well as the batch mode, however, semibatch processes are also conceivable, and metering strategies can be employed for the controlled addition of individual or multiple monomers and/or solvents and/or chain transfer systems, without departing the scope of the present invention.

As initiators for the radical polymerization it is possible to use all customary initiators known for acrylates or other monomers. The production of C-centered radicals is described in Houben Weyl, Methoden der Organischen Chemie, Vol. E 19a, pp. 60-147. These methods can be employed in analogy. Examples of radical sources are peroxides, hydroperoxides, and azo compounds; as some nonexclusive examples of typical radical initiators, mention may be made here of potassium peroxodisulfate, dibenzoyl peroxide, cumene hydroperoxide, cyclohexanone peroxide, di-tert-butyl peroxide, azodiisobutyronitrile, cyclohexylsulfonyl acetyl peroxide, diisopropyl percarbonate, tert-butyl peroctoate, and benzpinacol. In one very preferred variant the initiators are added in two or more stages, and so the conversion is raised to more than 90%. The residual monomer content remaining in the polymer can be lowered in this way to below 10% by weight.

The initiators can advantageously be added to the monomer solution before or at the beginning of the polymerization, and it is also possible to meter in initiators subsequently during the polymerization. The initiators are used preferably in a fraction of 0.001% to 1% by weight, more preferably of 0.025% to 0.1% by weight, based on the monomer mixture, in the reaction solution.

The initiators used for initiating the polymerization are preferably selected such that they exhibit a low tendency to form side chains in the polymers; their grafting activity is preferably below a value of ε<5 at the temperature of the reaction mixture when the initiator is added. Toward the end of the polymerization it is appropriate for there to be a final initiation with an initiator of higher grafting activity, in order to bring the residual monomer fraction close to 0% or even to eliminate it entirely.

As solvents in connection with this invention it is possible in principle to employ all the solvents familiar to the skilled person for the implementation of polymerizations. Here, water is possible, as are organic solvents, more particularly aliphatic or aromatic hydrocarbons, esters, and ethers. Examples of organic solvents which are highly suitable are acetone, benzine (special-boiling-point spirit), ethyl acetate, methyl ethyl ketone, toluene, xylene, and butyl acetate. Mixtures are likewise conceivable. The solvent (mixture) is preferably selected such that the polymerization can be carried out under conditions of evaporative cooling.

Polymerization processes in the sense of this invention for the preparation of multimodal, more particularly bimodal (co)polymers permit a reaction regime with high solids content and also a likewise high resultant solids content. The solids contents at the end of the polymerization are preferably at least 45% by weight, very preferably at least 50% by weight.

The polymer solutions obtained in this way are outstandingly suitable as constituents of coating formulations for adhesives such as pressure-sensitive adhesives or heat-sealing compositions.

In the course of the further processing of corresponding adhesive formulations based on the multimodal, more particularly bimodal, (co)polymers of the invention it is possible, in line with the high initial solids contents, to obtain solvent-containing coating formulations that are likewise of high solids content. This solids content is preferably at least 35% by weight, very preferably at least 45% by weight.

Adhesive formulations of the invention are preferably coated onto a web via a solvent coating process. As a result of the multimodality, and because of the existence of shorter-chain polymer chains, the result, with a high solids content, is a solution viscosity which is lower in comparison to monomodal, longer-chain polymers. This has the resulting advantage that adhesive formulations of the invention can be coated with coating patterns still of high optical quality even with a higher solids content. The increased solids content results in other processing advantages. For instance, only a smaller amount of solvent need be taken off in a solvent coating operation. When using the same dryer and the same dryer settings as for coating formulations with a lower solids content, this makes it possible to increase the web speed and hence to increase the profitability.

Since the PSAs of the invention can be coated with a higher solids content, there is also a lower solvent load on the dryer. It is therefore possible to coat PSA formulations of the invention with high solids content in a greater working width than would be possible, using the same drying and same dryer settings, in comparison to coating formulations with a lower solids content. This as well results in an increase in the profitability of the operation.

Furthermore, adhesive formulations of the invention with a high solids content of preferably at least 35% by weight, very preferably of at least 40% by weight, are preeminently suitable for realizing high adhesive coatweights. High adhesive coatweights in this context are those which after drying exhibit a film thickness of at least 75 μm. Even higher coatweights, of at least 125 μm and even above 200 μm, can be applied with a coating pattern of outstanding optical quality in relation, for example, to leveling and absence of bubbles. The coating materials can also be dried outstandingly, allowing adhesive layers with extremely low residual solvent contents to be realized. This result is assisted further by the choice of suitable solvents (mixtures). In this regard see, for example, the texts of Newman et al. [D. J. Newman, C. J. Nunn, J. K. Oliver, J. Paint. Technol., 1975, 47, 70-78; D. J. Newman, C. J. Nunn, Progr. Org. Coat., 1975, 3, 221-243]. Thinner coats as well, of course, can also be produced very effectively. They too are subjected to the statements made with regard to coating quality.

For coating it is possible in principle to employ all of the processes known to the skilled person, especially solvent-based coating processes. Roll, knife and nozzle processes may be given as examples.

These statements highlight the fact that multimodal, more particularly bimodal, (co)polymers of the invention are outstandingly suitable as constituents of pressure-sensitive adhesive formulations, and achieve the object not only of a balance in their performance properties (adhesion, cohesion) but also an improved processability. In comparison to monomodal polymers of high molecular weight, which have good adhesion with very good cohesion, it is possible to operate at a higher solids content with multimodal, more particularly bimodal, copolymers, for the same solution viscosity, and this leads to advantages in relation to production efficiency and/or attainable film thickness and/or degree of drying.

Via the processes of the invention it is possible to obtain multimodal, more particularly bimodal, (co)polymers which can be used outstandingly in pressure-sensitive adhesives. They can be used, for example, as at least one layer in single-sidedly or double-sidedly pressure-sensitively adhesive products, as a PSA layer.

Single-sidedly pressure-sensitively adhesive products comprise at least one layer of a PSA formulation comprising multimodal, more particularly, bimodal, (co)polymers of the invention. They further comprise at least one carrier material, a film, a woven fabric, a scrim or paper. The carrier material may carry further layers or have been chemically and/or physically pretreated. In particular, the side of the carrier that faces the PSA layer may have been given an adhesion-promoting undercoat (primer) and/or may have been treated by means of physical processes such as corona, plasma or flame. The side of the carrier which is not pointing toward the PSA layer may be equipped with a release coat, allowing the product to be wound up into rolls and unwound again for application. Alternatively, however, the PSA layer may also be lined with a release liner, a release paper or a release film, in order to protect the PSA layer from unwanted sticking or contamination until the point in time of its use.

Single-sidedly pressure-sensitively adhesive products can be converted as self-adhesive tapes, self-adhesive labels or self-adhesive sheets.

Double-sidedly pressure-sensitive adhesive products comprise at least one layer of a PSA formulation comprising multimodal, more particularly bimodal, copolymers of the invention. These products are, in particular, double-sided self-adhesive tapes or sheets, and preferably adhesive transfer tapes or sheets. Adhesive transfer tapes or sheets comprise at least one PSA layer, while double-sided self-adhesive tapes or sheets comprise at least two. Double-sided self-adhesive sheets and tapes, moreover, comprise at least one ply of a carrier material.

In order to protect the pressure-sensitive adhesive surfaces from contamination and unwanted premature sticking prior to the point of application, they are typically lined temporarily with redetachable auxiliary carrier materials, referred to as release liners. Where the double-sidedly pressure-sensitively adhesive products are in sheet form, their underside is lined using a sheet of a release liner material, and a second such sheet of release liner material is used for the top face. Where the double-sidedly pressure-sensitively adhesive products are converted in roll form, then it is possible likewise to employ two release liner materials or else a single sheet, which is prepared on the front and back faces in such a way that at the time of application it can be detached from the pressure-sensitive adhesive product again, initially from one pressure-sensitive surface and subsequently from the second such surface.

The construction of the double-sidedly pressure-sensitively adhesive products comprises a first release layer and a second release layer, and also, arranged between them, at least one PSA layer of the invention. Where the release layers are release layers of different release liners, then the liners used may have a different shape and/or size. For example, a release liner may, in its dimensions, protrude beyond the PSA layer and the other release liner. Likewise imaginable is a product construction in which the release liners have the same shape and/or size and protrude beyond the PSA layer in shape and/or size. In one embodiment, the double-sidedly pressure-sensitive adhesive product may take a form corresponding to a label sheet. Thus, for example, a first release liner may have a sheet form, while the PSA layer is applied thereto in the form of repeating (similarly label-shaped) sections which have been individualized by diecutting, for example. The second release liner may then likewise be confined solely to sections which repeat in the region of the pressure-sensitive adhesive, or may have a shape and/or size which corresponds essentially to the shape and/or size of the first release liner. In the latter case, however, in one advantageous embodiment, diecuts are provided in the second release liner in the region of the PSA areas.

Where carriers are employed with the pressure-sensitive adhesive products based on multimodal, more particularly bimodal, (co)polymers, then, without wishing to impose any restriction as a result of this recitation, it is possible, for producing this carrier film, to use all film-forming and extrudable polymers. In one preferred version, polyolefins are used. Preferred polyolefins are produced from ethylene, propylene, butylene and/or hexylene, and in each case it is possible to polymerize the pure monomers or to copolymerize mixtures of the stated monomers. Through the polymerization process and through the selection of the monomers it is possible to control the physical and mechanical properties of the polymer film, such as the softening temperature and/or the tensile strength, for example.

In a further preferred version of this invention, polyvinyl acetates are used as carrier base materials. Polyvinyl acetates may comprise, in addition to vinyl acetate, vinyl alcohol as well as a comonomer, the free alcohol fraction being variable within wide limits. In a further preferred version of this invention, polyesters are used as carrier film. In one particularly preferred version of this invention, polyesters based on polyethylene terephthalate (PET) are used. In particular, special, high-transparency PET films can be used. For example, films from Mitsubishi with the trade name Hostaphan™ or from Toray with the trade name Lumirror™ or from DuPont Teijin with the trade name Melinex™ are suitable. Another very preferred species of the polyesters are the polybutylene terephthalate films. Polyethylene naphthalate (PEN) is suitable as well. In a further preferred version of this invention, polyvinyl chlorides (PVC) are used as film. To increase the temperature stability it is possible for the polymer constituents present in these films to be prepared using stiffening comonomers. Furthermore, the films may be radiation-crosslinked in the course of the inventive procedure, in order to obtain the same improvement in properties. Where PVC is used as the raw material for the film, it may optionally comprise plasticizing components (plasticizers). In a further preferred version of this invention, polyamides are used for producing films. The polyamides may consist of a dicarboxylic acid and a diamine or of two or more dicarboxylic acids and diamines. Besides dicarboxylic acids and diamines it is also possible to use higher polyfunctional carboxylic acids and amines, also in combination with the aforementioned dicarboxylic acids and diamines. For stiffening the film it is preferred to use cyclic, aromatic or heteroaromatic starting monomers. In a further preferred version of this invention, polymethacrylates are used for preparing films. Here it is possible through the choice of the monomers (methacrylates and in some cases also acrylates) to control the glass transition temperature of the film. Furthermore, the polymethacrylates may also comprise additives, in order, for example, to increase the flexibility of the film or to raise or lower the glass transition temperature, or to minimize the formation of crystalline segments. In another preferred version of this invention, polycarbonates are used for producing films. Furthermore, in a further version of this invention, vinylaromatics- and vinylheteroaromatics-based polymers and copolymers may be used for producing the carrier film. An example is polystyrene (PS). Furthermore, polyethersulfone and polysulfone films may be used as carrier materials. These can be acquired, for example, from BASF under the trade name Ultrason™ E and Ultrason™ S. Furthermore, it is also possible with particular preference to use high-transparency TPU films. These are available commercially, for example, from Elastogran GmbH. Highly transparent films based on polyvinyl alcohol and polyvinylbutyral may be used as well.

For producing a material in film form it may be appropriate to add additives and other components which enhance the film-forming properties, reduce the tendency toward formation of crystalline segments, and/or specifically improve the mechanical properties or else, if appropriate, impair them.

Besides single-layer films, it is also possible to use multilayer films, which may be produced in coextruded form, for example. For this purpose it is possible to combine the abovementioned polymer materials with one another.

Furthermore, the films may be treated. Thus, for example, vapor deposition or sputtering operations may be performed, using, for example, aluminum, zinc oxide, SiOₓ or indium tin oxide, or varnishes or adhesion promoters may be applied. Another possible additization is of UV protectants, which may be present as additives in the film or may be applied as a protective layer.

The carrier film may also, for example, have an optical coating. Suitability as optical coating is possessed in particular by coatings which reduce the reflection. This is achieved, for example, through a reduction in the refractive-index difference for the air/optical coating transition.

Where release liners are employed with the pressure-sensitive adhesive products based on multimodal, more particularly bimodal, (co)polymers, these release liners may be release-treated on one or both sides. In order to produce single-sided or double-sided release liners it is likewise possible in principle to use all film-forming and extrudable polymers, which are preferably equipped on one or both sides with release systems. Examples can be found in the compilations by Satas, Kinning, and Jones that are cited at this point [D. Satas in “Handbook of Pressure Sensitive Adhesives Technology”, D. Satas (ed.), 3^{rd} edn., 1999, Satas & Associates, Warwick, pp. 632-651; D. J. Kinning, H. M. Schneider in “Adhesion Science and Engineering—Volume 2: Surfaces, Chemistry & Applications”, M. Chaudhury, A. V. Pocius (ed.), 2002, Elsevier, Amsterdam, pp. 535-571; D. Jones, Y. A. Peters in “Handbook of Pressure Sensitive Adhesives Technology”, D. Satas (ed.), 3^{rd} edn., 1999, Satas & Associates, Warwick, pp. 652-683].

Release liners are composed typically of a carrier film, which is furnished on one or both sides with a release varnish, which is preferably based on silicone. In one preferred version of this invention, polyolefins are used as carrier material for the release liners. Preferred polyolefins are produced from ethylene, propylene, butylene and/or hexylene, it being possible in each case to polymerize the pure monomers or to copolymerize mixtures of the stated monomers. Through the polymerization process and through the selection of the monomers it is possible to control the physical and mechanical properties of the polymer film, such as the softening temperature and/or the tensile strength, for example. One particularly preferred embodiment of this invention uses polyesters based on polyethylene terephthalate (PET) as carrier material for the release liners. In particular, special high-transparency PET films can be used. Suitability is possessed, for example, by films from Mitsubishi with the trade name Hostaphan™ or from Toray with the trade name Lumirror™ or from DuPont Teijin with the trade name Melinex™.

Furthermore, various papers, optionally also in combination with a stabilizing extrusion coating, are contemplated as carrier material for release liners. All of the stated release liners obtain their antiadhesive properties as a result of one or more coating operations, for example but preferably, with a silicone-based release. Application here may take place on one or both sides.

Release liners may, moreover, carry a fluoro-siliconization as release agent. Besides fluoro-silicone systems, coatings of fluorinated hydrocarbons on release liners are also contemplated.

All of the approaches familiar to the skilled person for adjusting the release properties of the release layers can be employed in principle in the context of this invention.

Compilations of control possibilities are compiled by Satas, Kinning, and Jones [D. Satas in “Handbook of Pressure Sensitive Adhesives Technology”, D. Satas (ed.), 3^{rd} edn., 1999, Satas & Associates, Warwick, pp. 632-651; D. J. Kinning, H. M. Schneider in “Adhesion Science and Engineering—Volume 2: Surfaces, Chemistry & Applications”, M. Chaudhury, A. V. Pocius (ed.), 2002, Elsevier, Amsterdam, pp. 535-571; D. Jones, Y. A. Peters in “Handbook of Pressure Sensitive Adhesives Technology”, D. Satas (ed.), 3^{rd} edn., 1999, Satas & Associates, Warwick, pp. 652-683]. This is important with double-sided release liners or with product designs featuring two release liners. For good handling properties, the release forces of the two release layers must be graduated.

The coatweights of the one or more PSA layers may be selected independently of one another. They are between 1 g/m² and 1000 g/m², more particularly between 10 g/m² and 500 g/m², very preferably between 20 g/m² and 300 g/m².

Where more than one PSA layer is employed, the layers may be identical or different in terms of chemistry, formulation and/or crosslinking state. Carrier-free versions as well may comprise two or more pressure-sensitive adhesive layers.

Where a carrier is employed in the double-sidedly pressure-sensitively adhesive products, then the film thickness, in one preferred version, is between 4 μm and 200 μm, more preferably between 12 μm and 100 μm. It is possible for more than one carrier film to be employed, selectable independently of one another in terms of raw material class, formulation, chemical properties, physical properties, surface treatment and/or thickness. Where two or more carrier plies are employed, they may be joined to one another by further pressure-sensitive adhesive layers or else other adhesive layers such as heat-seal or cold-seal layers.

Release liners furnished double-sidedly with release layers preferably have a thickness of at least 20 μm and of less than 150 μm. For release liners furnished single-sidedly with a release layer, the same range of values is preferred.

Where release liner combinations are employed, the thicknesses of a first release liner and of a second release liner may be the same or different. Suitable release liner thicknesses are again between 20 μm and 150 μm. Particularly advantageous release liner thickness combinations consist of release liners having thicknesses in the range of in each case 30 μm to 80 μm. Particularly advantageous release liner thickness combinations are 36 μm (thickness of the first release liner) and 50 μm (thickness of the second release liner) or vice versa, and also 50 μm and 75 μm or vice versa.

PSAs based on multimodal, more particularly bimodal, (co)polymers of the invention make it possible to provide pressure-sensitive adhesive products having a very advantageous combination of adhesive and cohesive properties (see examples). The basis for this is a particular viscoelastic characteristic. PSAs of the invention can be set in such a way, by means of appropriate crosslinking, that they are on the one hand partially “hard” (they have an enormous elastic component) and at the same time partially “soft” (they have a high bond strength). The elastic component may be more than 85%, without adversely affecting the bond strength. Even with a very high elastic component of more than 85%, the bond strength is at a higher level than in the case of a PSA based on monomodal polymers of high molecular weight. In accordance with the teaching of this invention, pressure-sensitive adhesive products are obtainable which have very good diecutting qualities, on the basis of their “hard” components in the viscoelastic profile. Highly diecuttable designs of this kind are also notable for an extremely low tendency toward adhesive oozing at the slit/diecut edges. The good diecuttability is manifested in rotary diecutting operations but also in the case of flatbed diecutting. Although such PSAs are partially “hard”, occasioning their suitability in the diecutting operation, they can be used very effectively at the same time in laminating operations. This is a result of “soft” components in the viscoelastic profile. This “softness” ensures good flow of the pressure-sensitive adhesive layer onto the substrate that is to be laminated.

On account of their particular performance properties balance and excellent coatability with a high-quality coating pattern, multimodal, more particularly bimodal, (co)polymers of the invention are outstandingly suitable for double-sidedly pressure-sensitively adhesive products, especially adhesive transfer tapes, for high-quality optical bonds, which may be mentioned here as one example application. For that purpose the PSA is designed as a straight acrylate—in other words, no tackifying resins are added to it in order to obtain an optimally water-clear and colorless adhesive layer. The multimodal, more particularly bimodal, character then results in increased bond strengths in conjunction with very good cohesion.

From multimodal, more particularly, bimodal (co)polymers of the invention it is therefore possible to formulate attractive PSAs whose use in (especially double-sidedly) pressure-sensitive adhesive products leads to laminating tapes and laminating sheets which have very good handling and diecutting properties. The invention hence produces pressure-sensitive adhesive products on the basis of PSAs that combine an applications-favorable balance of adhesive and cohesive properties with very good processability, and so represent an attractive solution to the problem posed.

Test Methods

Test method A—GPC:

The molecular weight distribution and in conjunction therewith the number average of the molecular weight distribution, Mₙ, the weight average of the molecular weight distribution M_{w}, and the maximum, in the case of monomodal copolymers, or the maxima, in the case of bimodal or multimodal copolymers, of the molecular weight distribution, Mₚ, were determined by gel permeation chromatography (GPC). The eluent used was THF with 0.1% by volume of trifluoroacetic acid. Measurement took place at 23° C. The preliminary column used was PSS SDV, 10 μ, 103 A, ID 8.0 mm×50 mm. Separation was carried out using the column combination PSS-SDV, 10 μ, linear-one with ID 8.0 mm×300 mm. The sample concentration was 1 g/l, the flow rate 0.5 ml per minute. Measurement took place against polystyrene standards. Mₚ values were determined graphically from the elugrams. Data processing was carried out using the WinGPC Unity software, version 7.20, from PSS.

Test method B—Bond Strength:

To determine the bond strength (peel strength) the procedure, in a method based on PSTC-1, is as follows: a pressure-sensitive adhesive layer 50 μm thick is applied to a PET film 25 μm thick. A strip of this sample 2 cm wide is adhered to a ground steel plate by being rolled over back and forth five times using a 5 kg roller. The plate is clamped in and the self-adhesive strip is pulled via its free end on a tensile testing machine under a peel angle of 180° and at a speed of 300 mm/min. The results are reported in N/cm.

Test Method C—Microshear Travel:

In a method based on ASTM D 4498, the procedure adopted is as follows: a sample 50 μm thick of an adhesive transfer tape is freed from the release liners and provided on one side, for stabilization, with an aluminum foil 50 μm thick. A test strip of 10 mm in width and about 50 mm in length is adhered to a steel plate in such a way as to result in a bond area of 130 mm². The bond is produced by rolling a 2 kg weight back and forth three times. The steel plate is adjusted in the measurement apparatus so that the test strip is present in vertical position and is conditioned at 30° C. The system is heated to 40° C. Using a clamp (weighing 6.4 g itself), a 500 g weight is affixed to the free end of the test strip, and loads the sample in shear as a result of gravitation. A micrometer gage is applied to a short section of the test adhesive strip, projecting beyond the steel plate, and this gage records the deflection as a function of the measuring time. The result for the microshear travel is the value recorded after a measuring time of 60 minutes. Also recorded is the elasticity, by de-suspending the weight after the shearing stress and monitoring the relaxation of the adhesive strip. After a further 60 minutes, the micrometer gage value is recorded and expressed as a percentage of the microshear travel under load. A high percentage value indicates a high elasticity, corresponding to high resilience on the part of the sample.

Test Method D—Chromaticity Coordinate b*:

The procedure adopted was in accordance with DIN 6174, and the color characteristics in three-dimensional space, governed by the three color parameters L*, a*, and b*, in accordance with CIELab, were investigated. This was done using a BYK Gardener spectro-guide instrument, equipped with a D/65° lamp. Within the CIELab system, L* indicates the gray value, a* the color axis from green to red, and b* the color axis from blue to yellow. The positive value range for b* indicates the intensity of the yellow color component. Serving as a reference was a white ceramic tile, with a b* of 1.05. This tile further acted as a sample mount, to which the adhesive layer under test is laminated. Color measurement takes place on the pure adhesive layer in each case, after this layer has been freed from the release liners.

Test Method E—Conversion Monitoring:

To monitor the conversion, the progress of the reaction, based on the unsaturated C═C double bonds of the provided monomers or monomer mixtures, is monitored in-line by means of a NIR (near-infrared) probe, which is connected via a waveguide to a NIR spectrometer. The probe is a “Quarz Lang” XN035-x NIR probe from Bruker, with an optical path length of 10 mm; the spectrometer is a Bruker IFS 28/N FT-NIR spectrometer. The measuring time per spectrum, corresponding to a measurement point for the conversion monitoring, is 4.4 s. A wavenumber range between 12 000 1/cm and 4000 1/cm is recorded. For conversion monitoring, in the case of acrylate monomers, the IR extinction is used which is caused by the first overtone vibration of the vinylic C—H bond at 6160 1/cm, this extinction being characteristic of these monomers and decreasing in the course of the polymerization as the monomers are used up. In the case of other monomers or monomer mixtures, the corresponding IR extinction caused by the first overtone vibration of the corresponding vinylic C—H bond is monitored. The extinction at 6160 1/cm in the case of acrylate monomers or at the corresponding wavenumber in the case of other monomers, prior to first initiation by a first addition of an initiator, serves as a starting value, and correspond to the value for a conversion of 0%. An extinction which can no longer be distinguished from the base line at the wavenumber under consideration corresponds to a conversion of 100%.

### EXAMPLES

### Example 1

A 2 l steel reactor conventional for radical polymerization is charged under a nitrogen atmosphere with 285 g of 2-ethylhexyl acrylate, 285 g of n-butyl acrylate, 6 g of 2-hydroxyethyl methacrylate, and 500 g of ethyl acetate. The reactor is heated to an internal temperature of 70° C. and the monomer mixture is initiated with 0.6 g of dibenzoyl peroxide. After 1 hour 30 minutes, subsequent initiation takes place with 0.3 g of benzoyl peroxide. The temperature at this point in time is 85° C. After a further 30 minutes, 35 g of a 3% acetone/ethyl acetate solution (1:1) of acetylcystein (ACC), as inventive chain transfer agent, and also a further 6 g of 2-hydroxymethyl acrylate are added. This point in time corresponds to a conversion of the monomers used, based on the C═C double bonds (measurement method E), of 72%. After further dilutions and final initiations, cooling takes place to 40° C. after 21 hours and 30 minutes, and the water-clear polymer is discharged.

A sample of the product is freed from the solvent in a vacuum drying cabinet. GPC analysis (test A) gave a bimodal molecular weight distribution with Mₚ(short)=31 000 g/mol and Mₚ(long)=850 000 g/mol. The fraction of the long-chain copolymers was 78%, that of the short-chain copolymers 22%.

A further sample of the polymerization solution is crosslinked with 0.6% of Desmodur L75, coated out using a doctor blade onto a siliconized polyester film 50 μm thick, and dried in the drying cabinet. The thickness of the pressure-sensitive adhesive layer was 50 μm. It is lined with one ply of a siliconized polyester liner 36 μm thick. This gave an adhesive transfer film. Appropriately dimensioned strips are subjected to test methods B and C. The results were a bond strength of 3.1 N/cm, a microshear travel of 437 μm, and an elastic component of 97%.

A color measurement by test method D gave a b* value of 1.15. No odor was given off by the specimens.

### Example 2 (Reference)

A 2 l steel reactor conventional for radical polymerization is charged under a nitrogen atmosphere with 285 g of 2-ethylhexyl acrylate, 285 g of n-butyl acrylate, 6 g of 2-hydroxyethyl methacrylate, and 500 g of ethyl acetate. The reactor is heated to an internal temperature of 70° C. and the monomer mixture is initiated with 0.6 mg of dibenzoyl peroxide. After 1 hour 30 minutes, subsequent initiation takes place with 0.3 g of benzoyl peroxide. The temperature at this point in time was 85° C. After a further 30 minutes, 120 g of isopropanol as chain transfer agent, and also a further 6 g of 2-hydroxymethyl acrylate are added. This point in time corresponds to a conversion of the monomers used, based on the C═C double bonds (measurement method E), of 69%. After further dilutions and final initiations, cooling takes place to 40° C. after 21 hours and 30 minutes, and the water-clear polymer is discharged.

A sample of the product is freed from the solvent in a vacuum drying cabinet. GPC analysis (test A) gave a bimodal molecular weight distribution with Mₚ(short)=30 000 g/mol and Mₚ(long)=800 000 g/mol. The fraction of the long-chain copolymers was 74%, that of the short-chain copolymers 26%.

A further sample of the polymerization solution is crosslinked with 0.6% of Desmodur L75, coated out using a doctor blade onto a siliconized polyester film 50 μm thick, and dried in the drying cabinet. The thickness of the pressure-sensitive adhesive layer was 50 μm. It is lined with one ply of a siliconized polyester liner 36 μm thick. This gave an adhesive transfer film. In the course of the attempt to prepare specimens for technical adhesive testing, difficulties occurred in removing the first release liner. The pressure-sensitive adhesive layer did not have sufficient cohesion for investigations by test methods B and C, and so this sample was not investigated further.

TABLE 1

| | Example 1 | Example 2 |
|---|---|---|
| | (invention) | (reference) |
| Type | bimodal polymer | bimodal polymer |
| MP(long) | 850 000 g/mol | 800 000 g/mol |
| MP(short | 31 000 g/mol | 30 000 g/mol |
| Fraction (long) | 78% | 74% |
| Fraction (short) | 22% | 26% |
| Chain transfer agent type | acetylcysteine | isopropanol |
| Crosslinker | 0.6% L75 | 0.6% L75 |
| Bond strength (steel) | 3.1 N/cm | not determined |
| Microshear travel | 4.37 μm, 97% | not determined |
| (40° C., 500 g) | elastic component | |
| b* value | 1.15 | not determined |
| Odor | none | not determined |

Table 1 summarizes the results of the examples. It can be seen that, by means of different chain transfer agents, it is possible to achieve similar results in relation to the molecular weight distribution, especially in terms of the modality. However, the differences in the different chain transfer systems are shown in the capacity of the polymers for further processing (Example 2). One approach and an explanation for this is that the amino acids used as chain transfer substances in accordance with the invention have a particularly high chain transfer constant. This permits the use of a far smaller amount of required chain transfer substance, in comparison to known chain transfer agents such as, for example, isopropanol. The isopropanol used in a large quantity in Example 2 is obviously responsible for the adverse effect on the performance properties. The examples further demonstrate that the process of the invention allows the provision of (co)polymers which on account of their color characteristics can be employed in optically high-grade adhesive bonding applications.

1. A radical (co)polymerization process comprising the steps of:
(a) providing a monomer or monomer mixture with unsaturated C═C double bonds;
(b) starting the radical (co)polymerization by a first addition of an initiator; and subsequently
(c) adding at least one amino acid as chain transfer substance,
the addition of the chain transfer substance taking place after attainment of a conversion of 50%, based on the unsaturated C═C double bonds of the monomer or monomer mixture provided in step (a).

2. The process of claim 1, wherein the addition of the chain transfer substance takes place until attainment of a conversion of 95%, based on the unsaturated C═C double bonds of the monomer or monomer mixture provided in step (a).

3. The process of claim 1, wherein the amino acid is added in step (c) in an amount of 0.05 to 5 mol %, based on the monomer or monomer mixture provided in step (a).

4. The process of any claim 1, wherein the amino acid is selected from the group consisting of amino acids containing thiol, selanyl, and hydroxyl groups.

5. The process of claim 4, wherein the amino acid has a terminal thiol, selanyl and/or hydroxyl group.

6. The process of claim 4, wherein the amino acid is N-acetylcysteine.

7. The process of claim 1, wherein the monomer mixture comprises at least one acrylic and/or methacrylic ester.

8. The process of claim 1 wherein the monomer mixture comprises at least 70% by weight of at least one acrylic and/or methacrylic ester.

9. A (co)polymer obtainable by the process of claim 1.

10. The (co)polymer of claim 9, wherein the (co)polymer is a (meth)acrylate copolymer which has at least one short-chain and one long-chain polymer mode (a) and (b):
(a) a short-chain polymer mode having a molecular weight M_{P}(short) of at least 5000 g/mol and not more than 100 000 g/mol, and
(b) a long-chain polymer mode having a molecular weight M_{P}(long) of at least 500 000 g/mol and not more than 3 000 000 g/mol.

11. The (co)polymer of claim 10, comprising at least 50% by weight of the long-chain polymer mode (b), based on the total amount of the short- and long-chain polymer modes (a) and (b).

12. A pressure-sensitive adhesive comprising the (co)polymer of claim 9.

13. A pressure-sensitive adhesive product comprising the pressure-sensitive adhesive of claim 12.
